(19) United States
(12) Patent Application Publication
(10) Pub. No.: US 2009/0303512 A1
(43) Pub. Date: Dec. 10, 2009

(54) AUTOMATED IMPOSITION FOR PRINT JOBS WITH EXCEPTION PAGES

(75) Inventor: Javier A. Morales, Rochester, NY (US)

Correspondence Address: Xerox Corporation;c/o ORTIZ & LOPEZ, PLLC, P. O. BOX 4484, ALBUQUERQUE, NM, 87196-4484, US

(73) Assignee: Xerox Corporation

(21) Appl. No.: 12/132,966

(22) Filed: Jun. 4, 2008

(51) Int. Cl. G06F 15/00

(52) U.S. Cl. 358/1.12

(57) ABSTRACT

Print jobs can be processed to produce printed documents. In industrial printing operations, printers operate on large sheets that are then folded, cut, and stacked. Individual pages are imposed onto the large sheets such that they end up in the correct place after stacking. Exception pages are pages that, for any of a variety of reasons, require special handling and thereby slow, possibly stop, the printing process. Automatically flattening print jobs before imposition and resolving media type definitions after imposition can remove the need for special handling and thereby increase printing efficiency.

### TECHNICAL FIELD

Embodiments relate to the fields of printed documents, printing processes, and electronic document specifications. Embodiments also relate to sheet imposition and exception page programming. Embodiments further relate to the fields of printing instructions, print jobs, print job control, and automatic publishing.

### BACKGROUND

With the development of data-processing systems, the printing industry can utilize automated imposition techniques for improving the productivity, quality, and efficiency of multiple page printing processes. Imposition refers to the process by which multiple pages can be printed on a single sheet of paper in a particular order so that the multiple pages can be output in the correct sequence. The single sheet of paper can be further cut and folded in order to further process a print job. The application of imposition techniques can include, but is not limited to commercial printing, magazines, newspapers, catalogs, books, business forms, greeting cards, maps, labels, packaging, and other printed products.

Imposition can be automatically performed by a computer using an imposition program. After printing, the printed sheets are typically folded and cut to generate sections of a document. The sections of the document can be combined to form the complete document. A page description language (PDL) can be used to specify the contents of a document. Before imposition, a PDL file can specify the content of each document page. An imposition program can accept a PDL file as input and produce an imposed PDL file. The imposed PDL file specifies the contents of entire sheets where pages of the document are automatically positioned, or imposed, onto an area of the sheet. The information about how specific document pages are imposed onto a sheet is often specified by an imposition template. Printing the sheets followed by other operations such as folding cutting and binding produces the individual document pages. Imposition programs, however, are not very flexible for the alteration of certain parameters, such as media type, for different pages within a processing job. This is particularly the case when media programming conflicts occur. The media type onto which each page is to be printed can be specified by media programming instructions in the PDL file. Different pages can be specified as having different media types. A media programming conflict occurs when pages having different types are imposed onto the same sheet. In such cases, automatic imposition rarely produces acceptable results and a human operator must resolve the media programming conflict. Human intervention is time consuming and can slow down an entire printing facility.

A plex exception is another type of page exception. Simplex printing occurs when only one side of a sheet is printed. Duplex printing occurs when both sides of a sheet are printed. A plex exception can occur when a document is specified as duplex contains a page specified as simplex. In such as case, human intervention is usually required to assure the imposed sheet, which will be duplex printed, is blank on the backside of the simplex page.

Many PDL files contain exception page programming. For example, a PDL file specifying a media type for an entire document and can use exception page programming, such as media programming instructions, to specify different media types for specific pages. The specific pages are called exception pages. Imposition programs are typically unaware of exception pages and exception page programming. As such, human interaction is required to resolve any and all of the conflicts that can arise from imposing exception pages. A need therefore exists for methods and systems that perform automated imposition of a PDL file having exception page programming.

### BRIEF SUMMARY

The following summary is provided to facilitate an understanding of some of the innovative features unique to the present invention and is not intended to be a full description. A full appreciation of the various aspects of the embodiments disclosed herein can be gained by taking the entire specification, claims, drawings, and abstract as a whole. Aspects of the embodiments address limitations and flaws in the prior art by automatically transforming page exceptions such that imposition and printing can proceed through a more normal process flow.

It is therefore an aspect of the embodiments to obtain a print job. The print job has an imposition specification as well as page descriptions. The page descriptions can be in the form of one or more files of page description language (PDL) information and programming. A PDL file can specify input pages that, once properly assembled, form a document. The print job contains exception page programming that, when processed, produce exception pages. The exception page programming can cause plex exceptions, media exceptions or both plex exceptions and media exceptions.

Plex exceptions occur when pages having different plex specifications are to be imposed onto the same sheet. For example, a simplex page can be imposed onto a sheet along with a number of duplex pages. Padding a blank page after the simplex page can resolve the plex exception when the blank page is imposed onto the sheet area opposite the simplex page. This allows the sheet to be duplex printed while the simplex page has printing on only one side.

Media exceptions occur when pages having different media types are to be imposed onto the same sheet. A sheet can have only one media type. A set of rules can be consulted for determining the media type of the sheet and thereby resolving the media exceptions.

It is therefore an aspect of certain embodiments to, without human intervention, flatten the print job before imposition by resolving plex exceptions. The print job is then imposed.

It is an aspect of some embodiments to resolve media exceptions after imposition.

It is an aspect of some other embodiments to detect sheets that are not specified as simplex but that can be printed simplex and to then to redefine those sheets as simplex such that they actually are simplex printed.

It is a further aspect of the embodiments to produce a document by rendering the print job.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the background of the invention, brief summary of the invention, and detailed description of the invention, serve to explain the principles of the present invention.

FIG. 1 illustrates a system that obtains a print job from a server and produces a printed publication in accordance with aspects of the embodiments;

FIG. 2 illustrates impositions resulting from a print job after flattening in accordance with aspects of the embodiments;

FIG. 3, labeled as “Prior Art”, illustrates some media types that can be used when flattening a print job;

FIG. 4, labeled as “Prior Art”, illustrates plex types that can be used when flattening a print job;

FIG. 5, labeled as “Prior Art”, illustrates imposition types that can be used when flattening a print job;

FIG. 6, labeled as “Prior Art”, illustrates exception page programming that can be flattened;

FIG. 7 illustrates resolving media type differences in accordance with aspects of the embodiments;

FIG. 8 illustrates a high level flow diagram of flattening a print job and producing a document in accordance with aspects of the embodiments;

FIG. 9 illustrates a high level flow diagram of determining if a print job is suitable for flattening in accordance with aspects of the embodiments;

FIG. 10 illustrates a high level flow diagram of rules being applied to flatten a print job in accordance with aspects of the embodiments;

FIG. 11 illustrates a mapping between an input page and an imposed sheet in accordance with aspects of the embodiments; and

FIG. 12 illustrates detecting simplex pages in accordance with aspects of the embodiments

### DETAILED DESCRIPTION OF THE INVENTION

The particular values and configurations discussed in these non-limiting examples can be varied and are cited merely to illustrate embodiments and are not intended to limit the scope of the invention.

Print jobs can be processed to produce printed documents. In industrial printing operations, printers operate on large sheets that can then be folded, cut, stacked, and bound. Individual pages are imposed onto the large sheets such that they end up in the correct positions after stacking. Exception pages are pages that, for any of a variety of reasons, require special handling and thereby slow, possibly stop, the printing process. Automatically flattening print jobs before imposition and resolving media type definitions after imposition can remove the need for special handling and thereby increase printing efficiency.

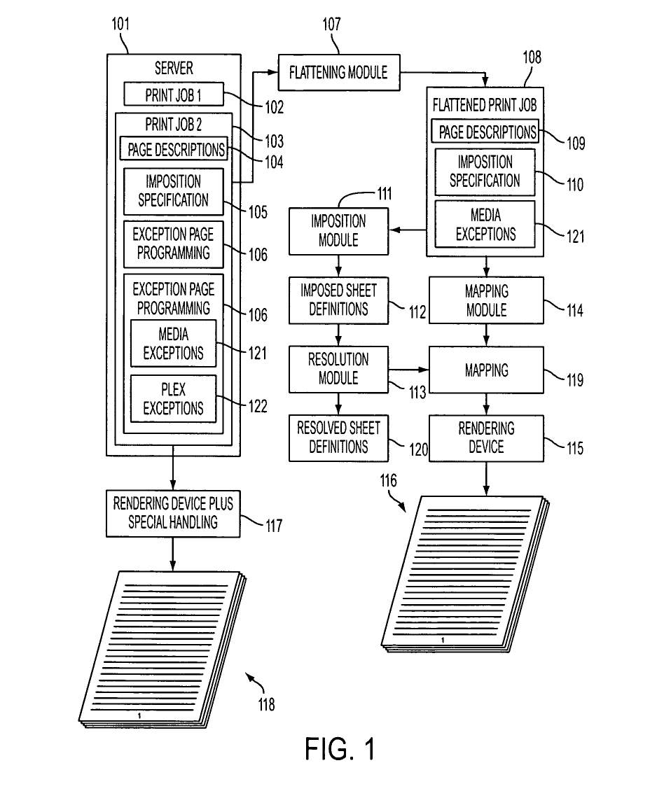

FIG. 1 illustrates a system that obtains a print job from a server 101 and produces a printed publication 116, 118 in accordance with aspects of the embodiments. A server 101 stores a number of print jobs such as print job 1 102 and print job 2 103. Print job 2 contains page descriptions 104, an imposition specification 105, and exception page programming 106. The exception page programming can contain plex exceptions 122 and media exceptions 121. The page descriptions 104 often contain the exception page programming 106, but such is not always the case. A flattening module 107 obtains print job 2 103 from the server 101 and determines if it is suitable for flattening. If it is not, then the flattening module 107 rejects print job 2 103 which can then be rendered by a rendering device plus special handling 117 to produce a document 118. A person provides the special handling.

If print job 2 103 is suitable for flattening, then the flattening module 107 can flatten it by resolving the plex exceptions 122 to produce a flattened print job 108 consisting of page descriptions 109 an imposition specification 110, and the media exceptions 121. An imposition module 111 can use the flattened print job 108 to produce imposed sheet definitions 112. A mapping module 114 produces a mapping 119 to track the pages printed on each sheet and thereby to identify media programming difference types. A resolution module 113 can resolve the media programming type differences amongst the imposed sheets to produce resolved sheet definitions 120. Finally, a rendering device 115 produces the document 116.

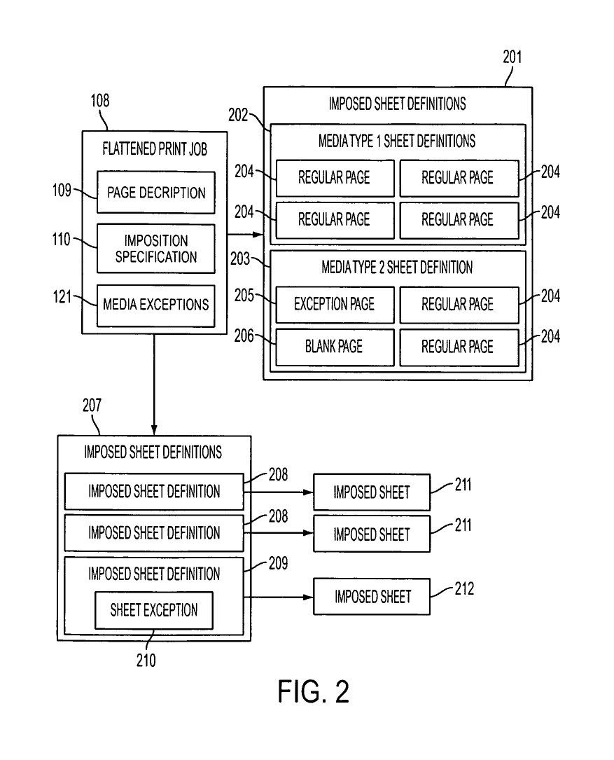

FIG. 2 illustrates impositions 201, 207 resulting from a print job 103 after flattening in accordance with aspects of the embodiments. Imposed sheet definitions 201 illustrates an imposition of the print job 103 onto two types of sheets. The first sheet type is media type 1 and each of the media type 1 definitions 202 specifies four regular pages 204. The exception page programming 114 specifies printing an exception page 205 onto media type 2. Print job flattening can result in a media type 2 sheet definition 203 specifying two regular pages 204, the exception page 205, and an inserted blank page 206 being imposed onto a single media type 2 sheet.

Another imposed sheet definitions 207 has two imposed sheet definitions 208 consisting of regular pages destined for the same media type. Each imposed sheet definition 208 can be printed to produce an imposed sheet 211. The exception page programming 114 is mapped to a sheet exception 210 in imposed sheet definition 209. A sheet exception 210 can cause a rendering device to draw a different type of sheet than that used for the rest of the document or to treat a sheet differently to produce imposed sheet 212. Rendering devices, such as industrial scale printers, operate on large sheets of media that are usually much larger than a document page. Mapping page exceptions to sheet exceptions can result in the printer processing exception pages without slowing down. Note that media type 2 sheet definition 203 can have a sheet exception.

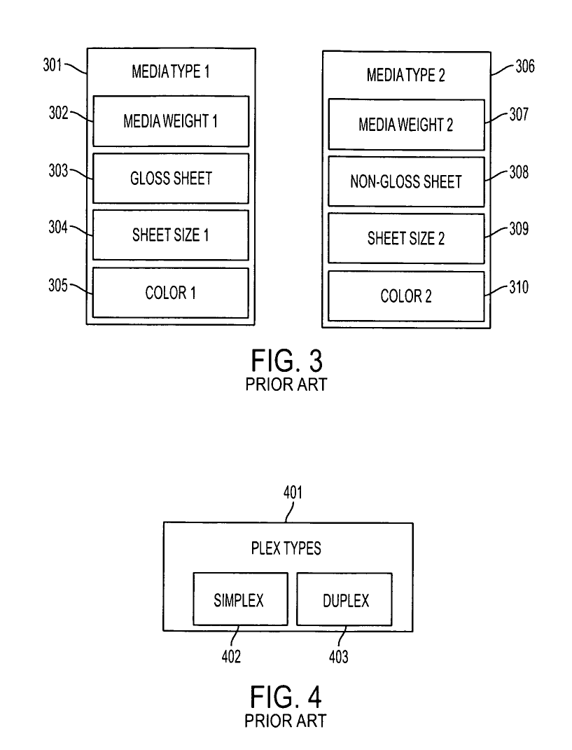

FIG. 3, labeled as “Prior Art”, illustrates some media types that can be used when flattening a print job. Media type 1 301 is a gloss sheet 303 having media weight 1 302, sheet size 1 304, and color 1 305. Media type 2 306 is a non-gloss sheet 308 having media weight 2 307, sheet size 2 309, and color 2 310.

FIG. 4, labeled as “Prior Art”, illustrates plex types 401 that can be used when flattening a print job. Simplex 402 is one page per sheet. Duplex 403 is two pages per sheet. Plex specifies the sides of the sheet which will be imaged

FIG. 5, labeled as “Prior Art”, illustrates imposition types 501 that can be used when flattening a print job.

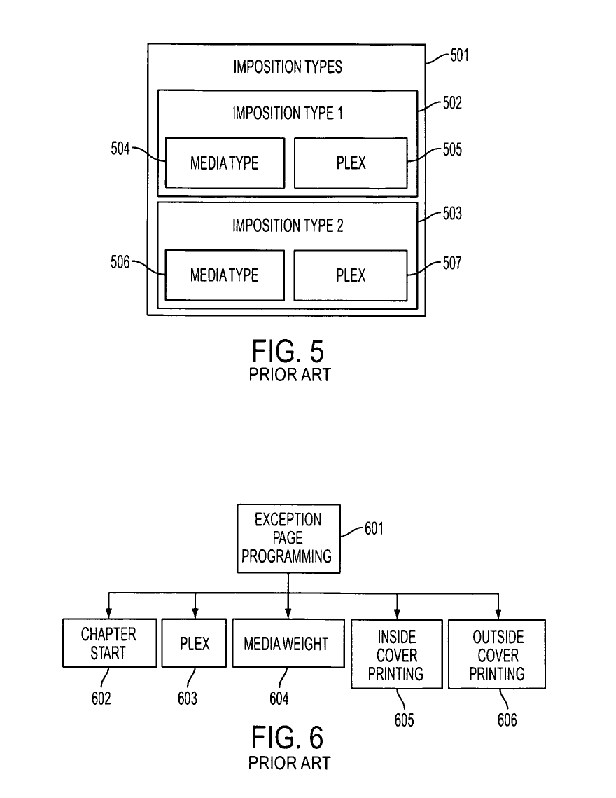

FIG. 6, labeled as “Prior Art”, illustrates exception page programming 601 A page can be an exception page because it is a chapter start 602, requires a different plex 603 or media weight 604 than the rest of the document, is an inside cover 605 or is an outside cover 606. There are numerous other types of exception pages.

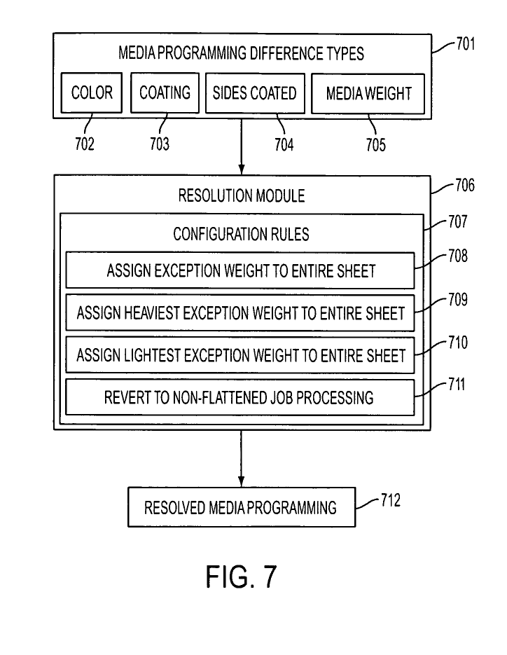

FIG. 7 illustrates resolving media type differences in accordance with aspects of the embodiments. A page can be an exception page because of its media programming. Media programming specifies the media onto which a page should be printed. Media programming differences can be classified into a variety of media programming difference types 701 such as differences in color 702, coating 703, sides coated 704, or media weight 705. A resolution module 706 examines the media types for a number of pages and determines if the differences can be resolved such that the pages can be imposed on a single sheet. The resolution module 706 can be rule based, meaning it uses configuration rules 707. One rule can be to assign the exception weight to the entire sheet so that the exception page is printed on the correct media and any other sheets imposed with the exception page also get the exception weight. If multiple exception pages are imposed on the same sheet, then the heaviest weight 709 or the lightest weight 710 can be assigned to the entire sheet. If there is no acceptable resolution, then the exception page can remain unchanged by reverting to non-flattened processing 711. Applying the rules results in resolved media programming 712.

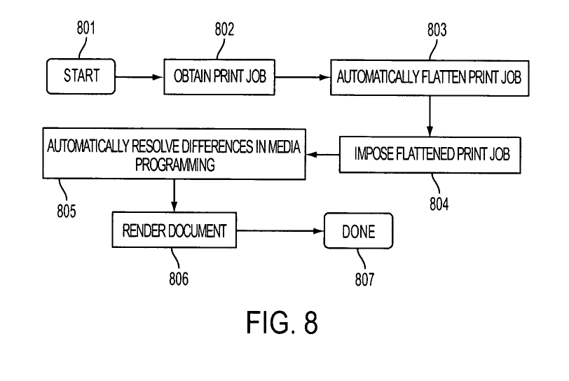

FIG. 8 illustrates a high level flow diagram of flattening a print job and producing a document in accordance with aspects of the embodiments. After the start 801 a print job is obtained 802 and automatically flattened 803. The flattened print job is then imposed 804 and differences in media programming resolved 805. The document is rendered 806 before the process is done 807.

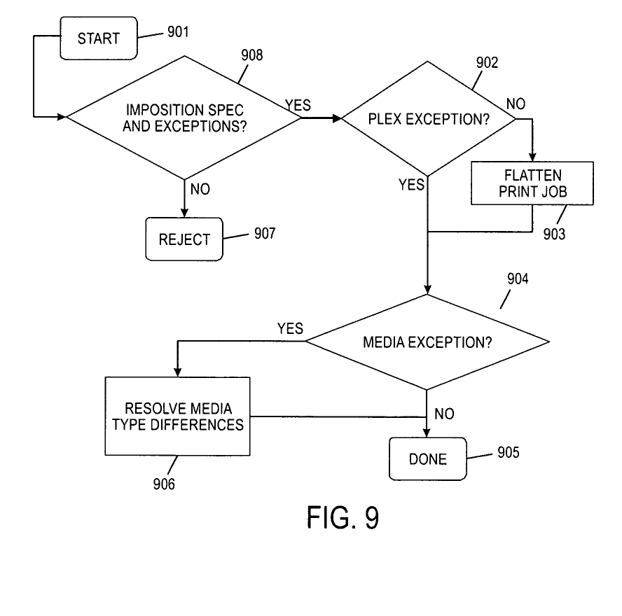

FIG. 9 illustrates a high level flow diagram of determining if a print job is suitable for flattening in accordance with aspects of the embodiments. After the start 901 the print job is examined to determine if it contains both exception page programming and an imposition specification 908. If it does not contain both, then the job is rejected 907. Otherwise, the print job can be, in certain embodiments, examined to determine if the exception page programming is a plex exception 902. If so, the job is flattened 903 before checking for media exceptions 904. Otherwise, the process proceeds directly to checking for media exceptions 904. If there are no media exceptions, the process is done 905. Otherwise, the media type differences are resolved 906 before the process is done 905.

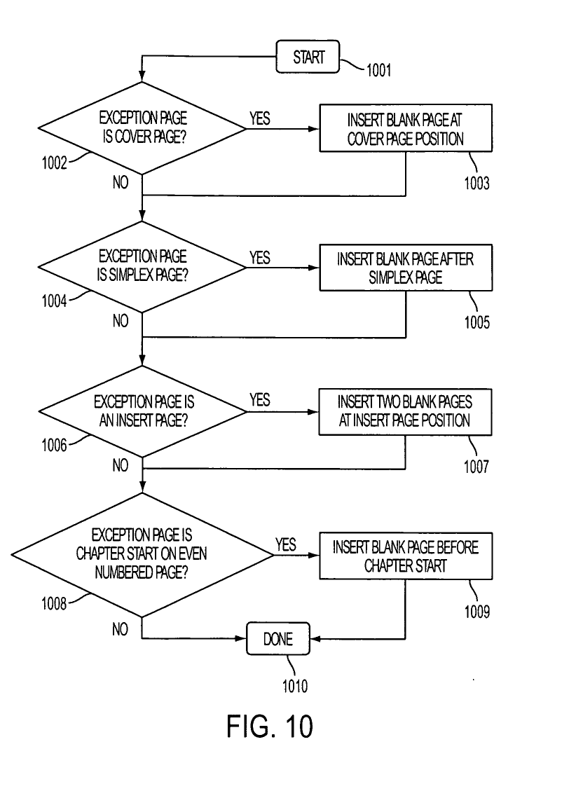

FIG. 10 illustrates a high level flow diagram of rules being applied to flatten a print job in accordance with aspects of the embodiments. Note that certain of the illustrated rules assume two sided or duplex printing. After the start 1001 a number of decision blocks are traversed before the process is done 1010. If the exception page is a cover page 1002, then a blank page can be inserted at the cover page position 1003. If the exception page is a simplex page 1004, then a blank page can be inserted after the simplex page 1005. If the exception page is an insert page 1006, then two blank pages can be inserted at the insert page position 1007. If the exception page is a chapter start on an even number page 1008, then a blank page can be inserted before the chapter start page 1009.

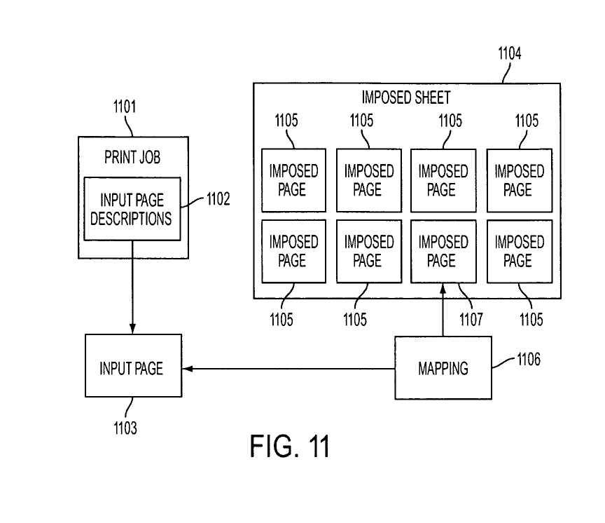

FIG. 11 illustrates a mapping between an input page and an imposed sheet in accordance with aspects of the embodiments. A print job 1101 contains input page description 1102 that describe input pages such as input page 1103. An imposed sheet has many imposed pages 1105, 1107 of which only one imposed page 1107 corresponds to input page 1103. A mapping 1106 determines where on the imposed sheet 1104 imposed page 1107 occurs. As such, after rendering, the imposed sheet 1104 can be folded and cut to produce input page 1103 at the correct place in a document. Note that the flattening process can introduce blank pages, such as those placed in the position of inserts, that are to be removed and possibly replaced with other materials. The mapping 1106 can be used to automatically locate the page to replace.

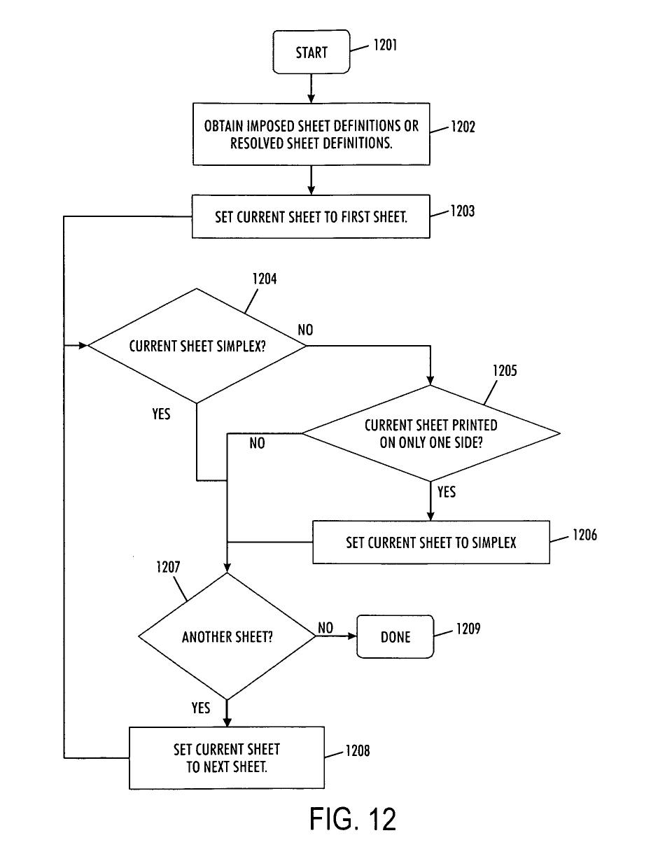

FIG. 12 illustrates detecting simplex pages in accordance with aspects of the embodiments. After the start 1201 either the imposed sheet definitions or the resolved sheet definitions are obtained 1202. The first sheet is set as the current sheet 1203. Then, if the current sheet is already simplex 1204 then the process checks to see if there are any more sheets to check 1207. If not, the process is done 1209. Otherwise, then the next sheet is set as the current sheet 1208 and the process loops back to checking if the current sheet is already simplex 1204. If the current sheet is not already simplex 1204, then the sheet is examined to determine if it is to be printed on only one side 1205. If so, then the sheet definition is modified such the current sheet becomes simplex 1206 before the availability of another sheet is determined 1207.

Embodiments can be implemented in the context of modules. In the computer programming arts, a module can be typically implemented as a collection of routines and data structures that performs particular tasks or implements a particular abstract data type. Modules generally can be composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules, hardware modules, or implementations thereof. Such modules can be utilized separately or together to form a program product that can be implemented through signal-bearing media, including transmission media and recordable media.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method comprising:
obtaining a print job comprising an imposition specification, exception page programming and a multiplicity of page descriptions specifying a multiplicity of pages, wherein the exception page programming comprises at least one plex exception;
automatically flattening the print job to produce a flattened print job wherein flattening comprises resolving the at least one plex exception;
imposing the flattened print job to define at least one imposed sheet; and
producing a document from the at least one imposed sheet.

2. The method of claim 1 wherein the exception page programming further comprises at least one media exception and further comprising:
determining a mapping that locates at least one media programming difference caused by the at least one media exception wherein a media programming difference occurs when two of the pages imposed one of the at least one imposed sheet have different media types;
automatically resolving the at least one media programming difference.

3. The method of claim 2 wherein the exception page programming is directed to inside cover printing or outside cover printing.

4. The method of claim 2 wherein the exception page programming is directed to the media weight of at least one exception page.

5. The method of claim 2 wherein the exception page programming is directed to the plex of at least one exception page.

6. The method of claim 2 wherein the exception page programming is directed to at least one exception page that is a chapter start.

7. The method of claim 2 wherein automatically resolving differences in media programming is performed by a resolution module comprising at least one configuration rule.

8. The method of claim 7 wherein the media programming difference is selected from the group consisting of color, coating, media weight, and sides coated.

9. A method comprising:
obtaining a print job comprising an imposition specification, exception page programming and a multiplicity of page descriptions specifying a multiplicity of pages, wherein the exception page programming comprises at least one plex exception and wherein processing the exception page programming produces at least one exception page;
automatically flattening the print job to produce a flattened print job wherein flattening comprises resolving the at least one plex exception;
imposing the flattened print job to define at least one imposed sheet;
a step for specifying that one of the at least one imposed sheets is simplex when that one of the at least one imposed sheet is to be printed on only one side and is not already specified as simplex, and
producing a document from the at least one imposed sheet.

10. The method of claim 1 wherein the exception page programming further comprises at least one media exception and further comprising:
determining a mapping that locates at least one media programming difference caused by the at least one media exception wherein a media programming difference occurs when two of the pages imposed one of the at least one imposed sheet have different media types;
automatically resolving the at least one media programming difference.

11. The method of claim 9 further comprising inserting at least one blank page into the print job at the position of at least one cover page wherein the at least one exception page comprises the at least one cover page.

12. The method of claim 9 further comprising inserting a blank page after each of at least one simplex page wherein the at least one exception page comprises the at least one simplex page.

13. The method of claim 9 further comprising inserting two blank pages at the location of an insert wherein the at least one exception page comprises the insert.

14. The method of claim 9 further comprising:
detecting a chapter start page having a page number that is even; and
inserting a blank page before the chapter start page to thereby cause the page number to become odd.

15. A method comprising:
obtaining a print job comprising an imposition specification, exception page programming and a multiplicity of page descriptions specifying a multiplicity of pages, wherein the exception page programming comprises at least one at least one media exception and wherein processing the exception page programming produces at least one exception page;
imposing the print job to define at least one imposed sheet;
determining a mapping that locates at least one media programming difference caused by the at least one media exception wherein a media programming difference occurs when two of the pages imposed one of the at least one imposed sheet have different media types;
automatically resolving the at least one media programming difference; and
producing a document from the at least one imposed sheet.

16. The method of claim 15 wherein the exception page programming further comprises at least one plex exception and further comprising automatically flattening the print job to before imposition wherein flattening comprises resolving the at least one plex exception.

17. The method of claim 16 further comprising a step for specifying that one of the at least one imposed sheets is simplex when that one of the at least one imposed sheet is to be printed on only one side and is not already specified as simplex.

18. The method of claim 17 wherein a resolution module comprising at least one configuration rule resolves the at least one media programming.

19. The method of claim 18 wherein one of the at least one the media programming difference is selected from the group consisting of color, coating, media weight, and sides coated.

20. The method of claim 19 further comprising:
inserting at least one blank page into the print job at the position of at least one cover page wherein the at least one exception page comprises the at least one cover page;
inserting a blank page after each of at least one simplex page wherein the at least one exception page comprises the at least one simplex page;
inserting two blank pages at the location of each of at least one insert wherein the at least one exception page comprises the at least one insert;
detecting a chapter start page having a page number that is even; and
inserting a blank page before the chapter start page to thereby cause the page number to be odd.
